(19) United States
(12) Patent Application Publication
(10) Pub. No.: US 2025/0378374 A1
(43) Pub. Date: Dec. 11, 2025

(54) LEARNING DEVICE, ALTERNATIVE SERIES DATA EXTRACTION DEVICE, LEARNING METHOD, ALTERNATIVE SERIES DATA EXTRACTION METHOD, AND COMPUTER PROGRAM

(71) Applicant: NIPPON TELEGRAPH AND TELEPHONE CORPORATION, Tokyo (JP)

(72) Inventors: Kensuke FUKUSHIMA, Tokyo (JP); Hisashi KURASAWA, Tokyo (JP); Masakuni ISHII, Tokyo (JP); Miyuki IMADA, Tokyo (JP); Yoshifumi FUKUMOTO, Tokyo (JP); Susumu YAMAMOTO, Tokyo (JP)

(73) Assignee: NIPPON TELEGRAPH AND TELEPHONE CORPORATION, Tokyo (JP)

(21) Appl. No.: 18/872,811

(22) PCT Filed: Jun. 9, 2022
(86) PCT No.: PCT/JP2022/023271

§ 371 Date: Dec. 7, 2024

(51) Int. Cl. G06N 20/00

(52) U.S. Cl. CPC G06N 20/00

(57) ABSTRACT

Provided is a learning device 1 including: a first learning unit 103 that learns a first model 3 that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event; and a second learning unit 104 that learns a second model 4 that estimates a specific series in which a peripheral series exists in the periphery from the peripheral series by using the training time series data.

### TECHNICAL FIELD

The disclosed technology relates to a learning device, an alternative series data extraction device, a learning method, an alternative series data extraction method, and a computer program.

### BACKGROUND ART

In the field of natural language processing, a technology for predicting a word appearing in the periphery of a certain word has been disclosed. For example, Non Patent Literatures 1 and 2 disclose a technology of expressing a word as a fixed-length vector (semantic vector) of several hundred dimensions in the field of natural language. According to this technology, it is possible to mathematically express closeness of meanings between words on the basis of a distribution hypothesis that words appearing in the same context have similar meanings.

### CITATION LIST

### Non Patent Literature

Non Patent Literature 1: Tomas Mikolov, Kai Chen, Greg Corrado, Jeffrey Dean Efficient Estimation of Word Representations in Vector Space, Internet <URL: https://arxiv.org/abs/1301.3781>
Non Patent Literature 2: Tomas Mikolov, Ilya Sutskever, Kai Chen, Greg S Corrado, Jeffrey Dean Distributed representations of words and phrases and their compositionality, Internet <URL: https://arxiv.org/abs/1310.4546>

### SUMMARY OF INVENTION

### Technical Problem

There is a case where it is desired to extract an action that has specifically changed before and after occurrence of an event in action series data of a user in which an expression frequency of one action changes in response to occurrence of the event. In the technology disclosed in the above Non Patent Literatures, the position of the word in the sentence in the natural language is considered, but the change in the series before and after the event is not considered. Therefore, in order to extract an action that has been specifically changed before and after occurrence of an event, only closeness of semantic vectors is insufficient in terms of interpretability.

The disclosed technology has been made in view of the above points, and an object thereof is to provide a learning device that creates a model for estimating a user's action that has specifically changed before and after occurrence of an event, an alternative series data extraction device that estimates a user's action that has specifically changed before and after occurrence of an event using the created model, and the like.

### Solution to Problem

A first aspect of the present disclosure is a learning device including: a first learning unit that learns a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event; and a second learning unit that learns a second model that estimates a specific series in which a peripheral series exists in the periphery from the peripheral series by using the training time series data.

A second aspect of the present disclosure is an alternative series data extraction device including: a first estimation unit that estimates a peripheral series of a predetermined series from the predetermined series including one or more items after occurrence of an event in estimation time series data including a series indicating an action of a user, the estimation time series data being assigned with a date and time information label indicating a date and time when an action is performed and a discrimination label for discriminating before and after occurrence of an event, by using a first model that has been generated by using the training time series data including a plurality of series indicating an action of the user and predicts a peripheral series of a series from the series including one or more items, each item of the training time series data being assigned with the date and time information label and the discrimination label; a conversion unit that converts contents of the discrimination label of the peripheral series estimated by the first estimation unit from after occurrence of the event to before occurrence of the event; and a second estimation unit that estimates a specific series from the peripheral series in the estimation time series data that has been estimated by the first estimation unit and whose contents of the discrimination label have been converted by the conversion unit, by using a second model that has been generated by using the training time series data and estimates a specific series in which a peripheral series exists in the periphery from the peripheral series.

A third aspect of the present disclosure is a learning method in which a computer executes processing of: generating a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event; and generating a second model that estimates a specific series in which a peripheral series exists in the periphery from the peripheral series by using the training time series data.

A fourth aspect of the present disclosure is an alternative series data extraction method in which a computer executes processing of: estimating a peripheral series of a predetermined series from the predetermined series including one or more items after occurrence of an event in estimation time series data including a series indicating an action of a user, the estimation time series data being assigned with a date and time information label indicating a date and time when an action is performed and a discrimination label for discriminating before and after occurrence of the event, by using a first model that has been learned using the training time series data including a plurality of series indicating an action of the user and predicts a peripheral series of a series from the series including one or more items, each item of the training time series data being assigned with the date and time information label and the discrimination label; converting contents of the discrimination label of the peripheral series estimated from after occurrence of the event to before occurrence of the event; and estimating a specific series from the peripheral series in the estimation time series data that has been estimated by using the first model and whose contents of the discrimination label have been converted, by using a second model that has been learned using the training time series data and estimates a specific series in which a peripheral series exists in the periphery from the peripheral series.

### Advantageous Effects of Invention

According to the disclosed technology, it is possible to provide a learning device that creates a model for estimating a user's action that has specifically changed before and after occurrence of an event, an alternative series data extraction device that estimates a user's action that has specifically changed before and after occurrence of an event using the created model, and the like.

### BRIEF DESCRIPTION OF DRAWINGS

FIG. 1 is a diagram illustrating an alternative series data extraction system according to the present embodiment.

FIG. 2 is a block diagram illustrating a hardware configuration of a learning device.

FIG. 3 is a block diagram illustrating an example of a functional configuration of the learning device.

FIG. 4 is a block diagram illustrating a hardware configuration of an alternative series data extraction device.

FIG. 5 is a block diagram illustrating an example of a functional configuration of the alternative series data extraction device.

FIG. 6 is a flowchart illustrating a flow of learning processing of a first model by the learning device.

FIG. 7 is a diagram illustrating an example of time series data according to the present embodiment.

FIG. 8 is a diagram illustrating an example of a state in which a date and time information label and a discrimination label are assigned to training time series data.

FIG. 9 is a flowchart illustrating a flow of learning processing of a second model by the learning device.

FIG. 10 is a flowchart illustrating a flow of alternative series data estimation processing by the alternative series data extraction device.

FIG. 11 is a diagram for explaining estimation processing of a peripheral series by the alternative series data extraction device.

FIG. 12 is a diagram for explaining processing of changing the content of the discrimination label by the alternative series data extraction device.

FIG. 13 is a diagram for explaining estimation processing of a specific series by the alternative series data extraction device.

### DESCRIPTION OF EMBODIMENTS

Hereinafter, an example of an embodiment of the disclosed technology will be described with reference to the drawings. In the drawings, the same or equivalent components and portions are denoted by the same reference signs. In addition, dimensional ratios in the drawings are exaggerated for convenience of description, and may be different from actual ratios.

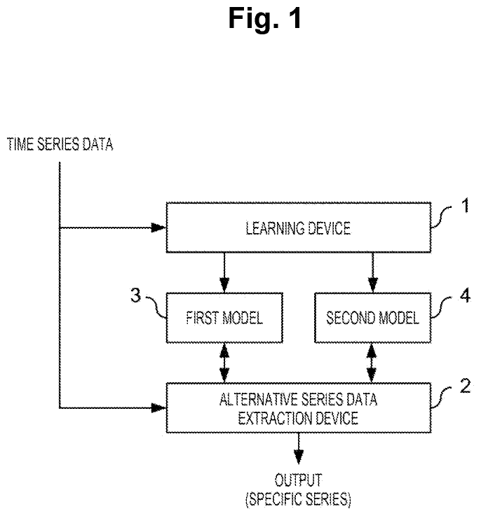

FIG. 1 is a diagram illustrating an alternative series data extraction system according to the present embodiment. The alternative series data extraction system illustrated in FIG. 1 includes a learning device 1 and an alternative series data extraction device 2.

The learning device 1 learns a first model 3 that estimates a peripheral series of a series from the series including one or more items by using time series data in which items having actions of a user recorded are recorded in time series, and a second model 4 that estimates a specific series in which a peripheral series exists in the periphery from the peripheral series by using the time series data. In the following description, the item is a use history of a service by a user, and the time series data is service use log data in which the use history of the service by the user is recorded. The time series data used by the learning device 1 for learning the first model 3 and the second model 4 is referred to as training time series data.

In the present embodiment, the learning device 1 learns the first model 3 by the Skip-Gram method and learns the second model 4 by the CBOW method. The Skip-Gram method is a method of predicting peripheral words from a certain central word by a two-layer neural network used to extract a semantic vector of word2vec. As in the present embodiment, in the time series data including the use history of the service by the user, the Skip-Gram method is suitable for estimating a series existing in the periphery of a certain series. In the present embodiment, the first model 3 is a Skip-Gram model which is a neural network learned by the Skip-Gram method.

Here, the series includes one or more items. In the present embodiment, the item is a service use log generated every time a user uses a service. The service may include all services that can be used by the user through a network such as the Internet, such as a music distribution service, a video distribution service, and a news distribution service.

Furthermore, the CBOW method is a method of predicting a central word from peripheral words by a two-layer neural network used to extract a semantic vector of word2vec, and is suitable when a specific series is estimated from a peripheral series in time series data including a service use history by a user as in the present embodiment. In the present embodiment, the second model 4 is a CBOW model which is a neural network learned by the CBOW method.

The alternative series data extraction device 2 estimates the action of the user that has specifically changed before and after the occurrence of the event using the first model 3 and the second model 4 with respect to the time series data to be estimated. In the present embodiment, the event is subscription of a new service by the user, and the action of the user that has changed is that the user no longer uses the service that has been used by the user due to the subscription of the new service. The alternative series data extraction device 2 estimates from which series (service) the series (service) existing only after the subscription is replaced on the premise that the disposable time of the person changes before and after the subscription of the new service. Of course, the event and the changed user's action are not limited to such an example. For example, the event may be cancellation of service subscription by the user, and the user's action that has been changed may be that the user has started to use a service that the user has not used before due to the cancellation of the service subscription.

In the present embodiment, the learning device 1 and the alternative series data extraction device 2 are separate devices, but the present disclosure is not limited to such an example, and the function of the learning device 1 and the function of the alternative series data extraction device 2 may be provided in the same device. In addition, the first model 3 or the second model may be stored in the learning device 1, may be stored in the alternative series data extraction device 2, or may be stored in another device that is neither the learning device 1 nor the alternative series data extraction device 2.

Next, a hardware configuration of the learning device 1 will be described.

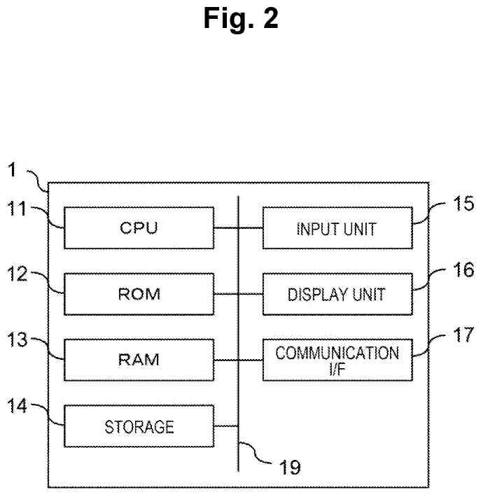

FIG. 2 is a block diagram illustrating a hardware configuration of the learning device 1.

As illustrated in FIG. 2, the learning device 1 includes a central processing unit (CPU) 11, a read only memory (ROM) 12, a random access memory (RAM) 13, a storage 14, an input unit 15, a display unit 16, and a communication interface (I/F) 17. The configurations are connected to each other to be able to communicate via a bus 19.

The CPU 11 is a central processing unit, which executes various programs and controls each unit. That is, the CPU 11 reads a program from the ROM 12 or the storage 14, and executes the program using the RAM 13 as a working area. The CPU 11 controls the above-described each component and performs various types of operation processing according to the program stored in the ROM 12 or the storage 14. In the present embodiment, the ROM 12 or the storage 14 stores a learning program that performs learning processing using time series data including a plurality of series indicating user's action.

The ROM 12 stores various programs and various types of data. The RAM 13 is a working area that temporarily stores programs or data. The storage 14 includes a storage device such as a hard disk drive (HDD) or a solid state drive (SSD), and stores various programs including an operating system and various data.

The input unit 15 includes a pointing device such as a mouse and a keyboard, and is used to perform various inputs.

The display unit 16 is, for example, a liquid crystal display and displays various types of information. The display unit 16 may function as the input unit 15 by adopting a touch panel system.

The communication interface 17 is an interface for communicating with other equipment. For the communication, for example, a wired communication standard such as Ethernet (registered trademark) or FDDI, or a wireless communication standard such as 4G, 5G, or Wi-Fi (registered trademark) is used.

Next, a functional configuration of the learning device 1 will be described.

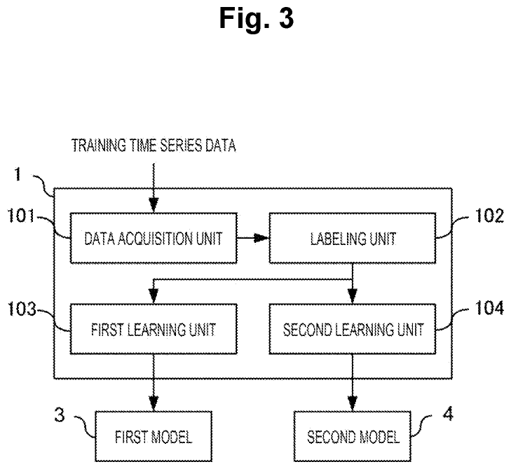

FIG. 3 is a block diagram showing an example of the functional configuration of the learning device 1.

As illustrated in FIG. 3, the learning device 1 includes a data acquisition unit 101, a labeling unit 102, a first learning unit 103, and a second learning unit 104 as functional configurations. Each functional configuration is realized by the CPU 11 reading a learning program stored in the ROM 12 or the storage 14, developing the learning program in the RAM 13, and executing the learning program.

The data acquisition unit 101 acquires training time series data of any length in which items having user's actions recorded are recorded in time series. In the present embodiment, the training time series data is service use log data in which a service use history by the user is recorded. The data length of the training time series data is desirably a length suitable for learning. It is assumed that the training time series data can be divided into a series of before subscription of the service and a series of after subscription of the service for each user.

The labeling unit 102 assigns, to each item of the training time series data acquired by the data acquisition unit 101, a date and time information label indicating a date and time when an action is performed and a discrimination label for discriminating before and after occurrence of an event. The information assigned to the item as the date and time information label may include date and time when the item occurs, a time zone attribute, a day attribute, and the like. The time zone attribute is, for example, morning, daytime, night, or late at night. The day attribute is, for example, weekday or weekend and holiday. The information assigned to the item as the date and time information label is information indicating before the occurrence of the event or after the occurrence of the event. When the labeling unit 102 assigns a date and time information label to the training time series data, it is possible to acquire a semantic vector in consideration of time. When the labeling unit 102 assigns a discrimination label to the training time series data, it is possible to acquire a semantic vector in consideration of a state of the presence or absence of occurrence of an event.

The labeling unit 102 may divide the training time series data to which each label is assigned into a training series of the first model 3 and the second model 4 and a training result verification series.

The first learning unit 103 learns the first model 3 that estimates the peripheral series of the series from a certain specific series by using the training time series data in which the date and time information label and the discrimination label are assigned to each item by the labeling unit 102. The first learning unit 103 uses the Skip-Gram method for learning the first model 3. In a case where the training time series data is divided into a training series and a training result verification series by the labeling unit 102, the first learning unit 103 learns the first model 3 using the training series and verifies the learning result using the verification series.

The second learning unit 104 learns the second model 4 that estimates a specific series in which a certain peripheral series exists in the periphery from the peripheral series by using the training time series data in which the date and time information label and the discrimination label are assigned to each item by the labeling unit 102. The second learning unit 104 uses the CBOW method for learning the second model 4. In a case where the training time series data is divided into a training series and a training result verification series by the labeling unit 102, the second learning unit 104 learns the second model 4 using the training series and verifies the learning result using the verification series.

With such a configuration, the learning device 1 can learn the first model 3 and the second model 4 by accurately considering the replacement relationship of the execution time of the user for each item and considering the presence or absence of the occurrence of the event using the training time series data in which the items having the user's action recorded are recorded in time series.

Next, a hardware configuration of the alternative series data extraction device 2 will be described.

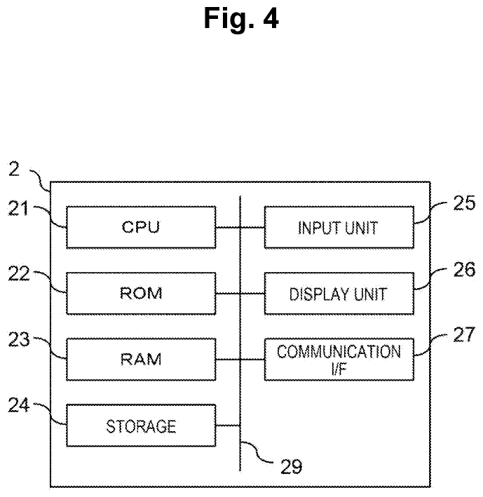

FIG. 4 is a block diagram illustrating a hardware configuration of the alternative series data extraction device 2.

As illustrated in FIG. 4, the alternative series data extraction device 2 includes a CPU 21, a ROM 22, a RAM 23, a storage 24, an input unit 25, a display unit 26, and a communication interface (I/F) 27. The components are communicably connected with each other via a bus 29.

The CPU 21 is a central processing unit, executes various programs, and controls each unit. That is, the CPU 21 reads a program from the ROM 22 or the storage 24, and executes the program using the RAM 23 as a working area. The CPU 21 performs control of each of the components described above and executes various types of calculation processing according to a program stored in the ROM 22 or the storage 24. In the present embodiment, the ROM 22 or the storage 24 stores an alternative series data estimation program that performs estimation processing of estimating a user's action that has changed before and after occurrence of an event, using time series data.

The ROM 22 stores various programs and various types of data. The RAM 23 as a working area temporarily stores programs or data. The storage 24 is configured with a storage device such as an HDD or an SSD, and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by adopting a touch panel system.

The communication interface 27 is an interface for communicating with other equipment. For the communication, for example, a wired communication standard such as Ethernet (registered trademark) or FDDI, or a wireless communication standard such as 4G, 5G, or Wi-Fi (registered trademark) is used.

Next, a functional configuration of the alternative series data extraction device 2 will be described.

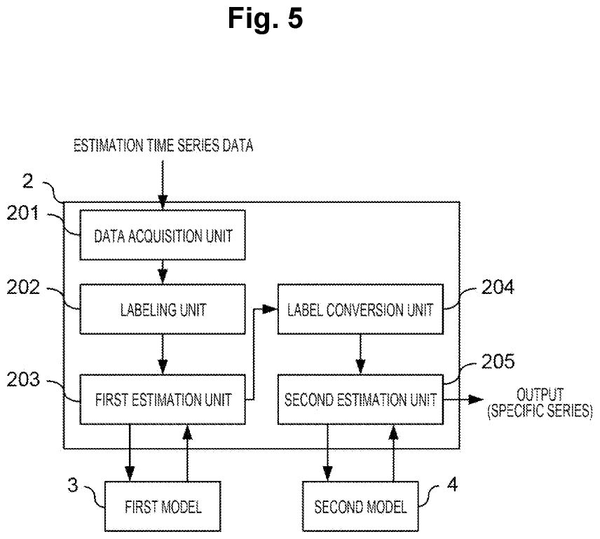

FIG. 5 is a block diagram illustrating an example of a functional configuration of the alternative series data extraction device 2.

As illustrated in FIG. 5, the alternative series data extraction device 2 includes a data acquisition unit 201, a labeling unit 202, a first estimation unit 203, a label conversion unit 204, and a second estimation unit 205 as functional configurations. Each functional configuration is achieved by the CPU 21 reading the alternative series data estimation program stored in the ROM 22 or the storage 24, loading the alternative series data estimation program onto the RAM 23, and executing the alternative series data estimation program.

The data acquisition unit 201 acquires estimation time series data in which items having user's actions recorded are recorded in time series. In the present embodiment, the estimation time series data is service use log data in which a service use history by the user is recorded. It is assumed that the estimation time series data can be divided into a series of before subscription of the service and a series of after subscription of the service for each user.

The labeling unit 202 assigns, to each item of the estimation time series data acquired by the data acquisition unit 201, a date and time information label indicating a date and time when an action is performed and a discrimination label for discriminating before and after occurrence of an event.

The first estimation unit 203 estimates a peripheral series of a predetermined series including one or more items in the estimation time series data to which a label is assigned. Specifically, the first estimation unit 203 inputs the predetermined series to the first model 3 and causes the first model 3 to output a peripheral series of the series, thereby estimating the peripheral series of the series from the predetermined series. The target of the predetermined series is the content of the discrimination label after the occurrence of the event.

The label conversion unit 204 converts the content of the discrimination label of the peripheral series estimated by the first estimation unit 203 from after the occurrence of the event to before the occurrence of the event.

The second estimation unit 205 estimates a series in which the peripheral series exists in the periphery from the peripheral series estimated by the first estimation unit 203 and obtained by converting the content of the discrimination label by the label conversion unit 204. Specifically, the second estimation unit 205 inputs the peripheral series to the second model 4, and outputs a series in which the peripheral series exists in the periphery from the second model 4, thereby estimating a series in which the peripheral series exists in the periphery.

With such a configuration, the alternative series data extraction device 2 can estimate a series limited to the semantic space before the occurrence of the event using the estimation time series data.

Next, actions of the learning device 1 will be described.

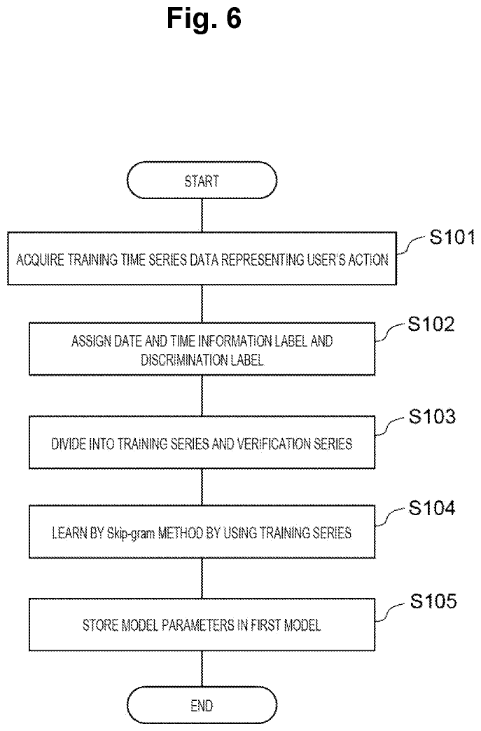

First, learning processing of the first model 3 by the learning device 1 will be described. FIG. 6 is a flowchart illustrating a flow of the learning processing of the first model 3 by the learning device 1. Learning processing of the first model 3 is performed by the CPU 11 reading a learning program from the ROM 12 or the storage 14, developing the learning program in the RAM 13, and executing the learning program.

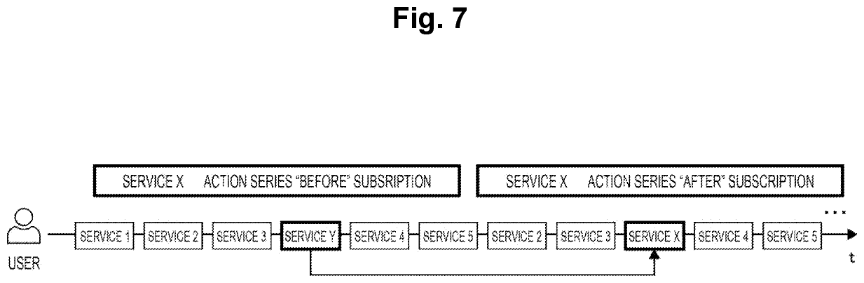

In step S101, the CPU 11 acquires training time series data representing the user's behavior. FIG. 7 is a diagram illustrating an example of time series data according to the present embodiment. In the present embodiment, the time series data is service use log data in which a service use history by the user is recorded.

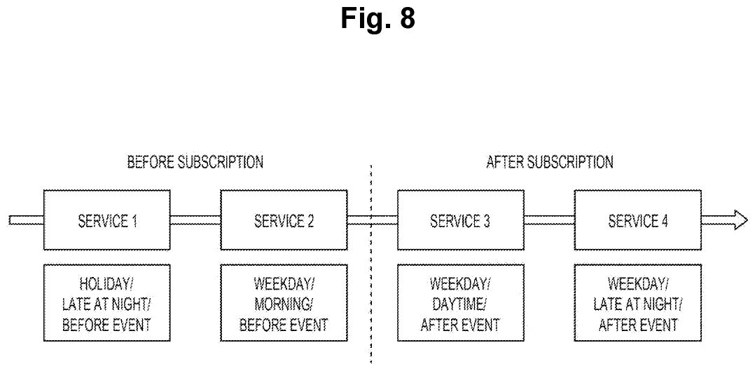

Following step S101, in step S102, the CPU 11 assigns, to each item of the training time series data acquired by the data acquisition unit 101, a date and time information label indicating a date and time when an action is performed and a discrimination label for discriminating before and after occurrence of an event. FIG. 8 is a diagram illustrating an example of a state in which a date and time information label and a discrimination label are assigned to training time series data. In the example of FIG. 8, information on a weekday, a holiday, or a time zone is assigned to an item as a date and time information label. In addition, in the example of FIG. 8, information for distinguishing between before and after the event is assigned to the item as a discrimination label.

Following step S102, in step S103, the CPU 11 divides the labeled training time series data into a training series and a verification series.

Following step S103, in step S104, the CPU 11 learns the first model 3 by the Skip-Gram method using the training series.

Following step S104, in step S105, the CPU 11 stores the model parameters determined by learning in step S104 in the first model 3.

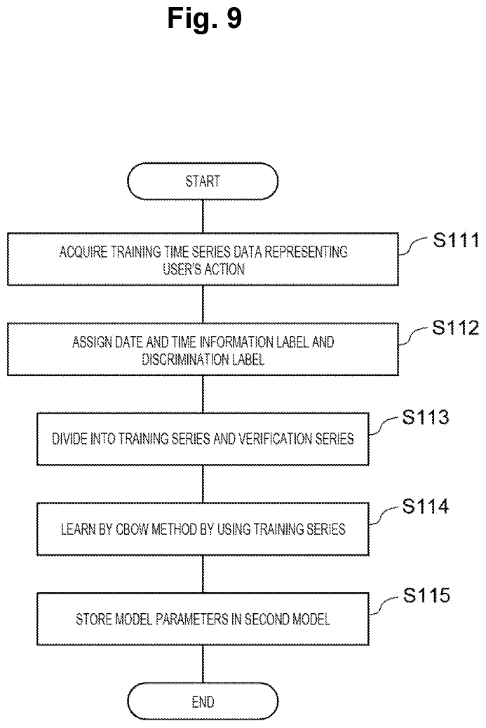

Subsequently, learning processing of the second model 4 by the learning device 1 will be described. FIG. 9 is a flowchart illustrating a flow of learning processing of the second model 4 by the learning device 1. Learning processing of the second model 4 is performed by the CPU 11 reading a learning program from the ROM 12 or the storage 14, developing the learning program in the RAM 13, and executing the learning program.

In step S111, the CPU 11 acquires training time series data representing the user's behavior. The time series data acquired by the CPU 11 is, for example, service use log data in which a service use history by the user is recorded as illustrated in FIG. 7.

Following step S111, in step S112, the CPU 11 assigns, to each item of the training time series data acquired by the data acquisition unit 101, a date and time information label indicating a date and time when an action is performed and a discrimination label for discriminating before and after occurrence of an event. FIG. 8 illustrates an example of a state in which a date and time information label and a discrimination label are assigned to training time series data.

Following step S112, in step S113, the CPU 11 divides the labeled training time series data into a training series and a verification series.

Following step S113, in step S114, the CPU 11 learns the second model 4 by the CBOW method using the training series.

Following step S114, in step S115, the CPU 11 stores the model parameters determined by learning in step S114 in the second model 4.

Next, actions of the alternative series data extraction device 2 will be described.

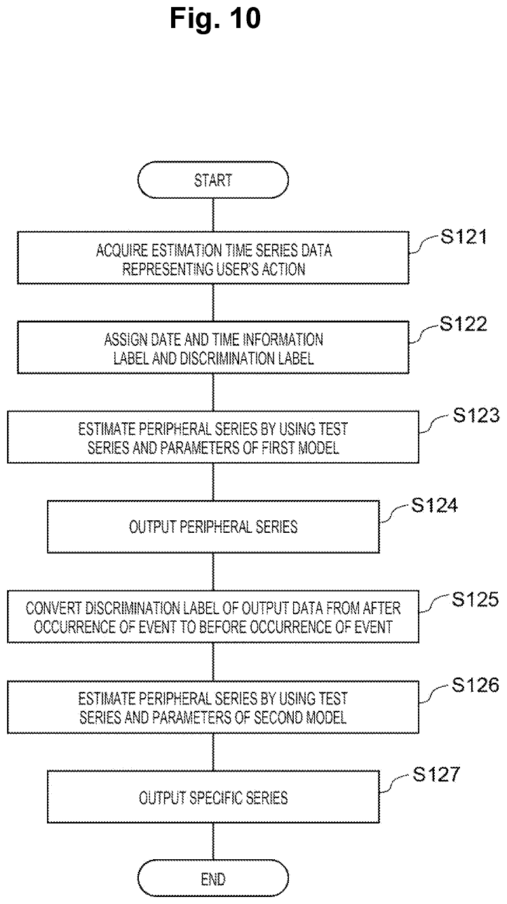

FIG. 10 is a flowchart illustrating a flow of alternative series data estimation processing by the alternative series data extraction device 2. The CPU 21 reads the alternative series data estimation program from the ROM 22 or the storage 24, develops the alternative series data estimation program in the RAM 23, and executes the alternative series data estimation program, thereby performing the alternative series data estimation processing.

In step S121, the CPU 11 acquires estimation time series data representing the user's behavior. The time series data acquired by the CPU 11 is, for example, service use log data in which a service use history by the user is recorded as illustrated in FIG. 7.

Following step S121, in step S122, the CPU 11 assigns, to each item of the estimation time series data acquired by the data acquisition unit 201, a date and time information label indicating a date and time when an action is performed and a discrimination label for discriminating before and after occurrence of an event. FIG. 8 illustrates an example of a state in which a date and time information label and a discrimination label are assigned to estimation time series data.

Following step S122, in step S123, the CPU 11 estimates the peripheral series of the series using the test series including a certain item of the estimation time series data and the parameter of the first model 3. The series is a series of items in which a label indicating after occurrence of an event is assigned to a discrimination label. In the present embodiment, a case where a user subscribes to a certain service X will be described as an example of an event.

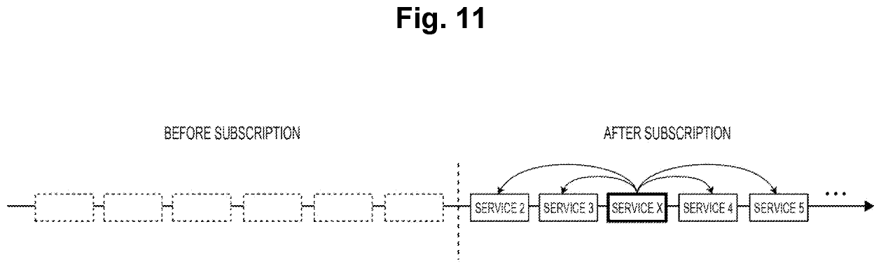

FIG. 11 is a diagram for explaining estimation processing of a peripheral series by the alternative series data extraction device 2. The example of FIG. 11 illustrates that “service 2”, “service 3”, “service 4”, and “service 5” are estimated as the peripheral series of “service X” that the user newly subscribes. That is, it can be seen that the user uses “service 2” and “service 3” before using “service X”, and uses “service 4” and “service 5” after using “service X”.

Following step S123, in step S124, the CPU 11 outputs the peripheral series estimated in step S123.

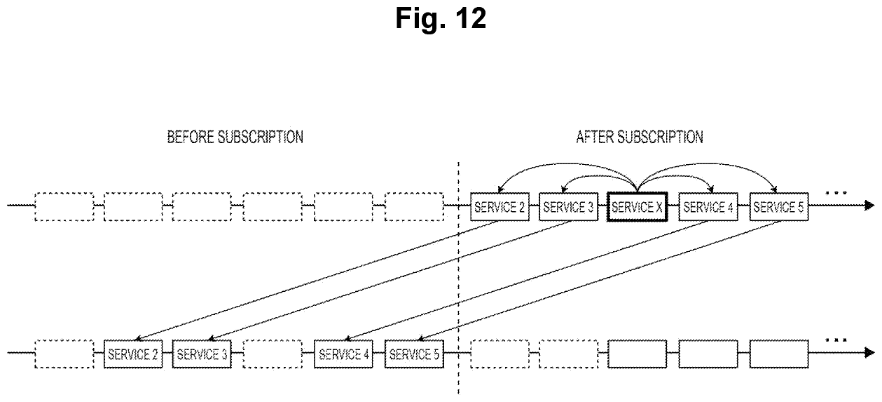

Following step S124, in step S125, the CPU 11 converts the contents of the discrimination labels in the peripheral series output in step S124 from after the occurrence of the event to before the occurrence of the event. FIG. 12 is a diagram for explaining processing of changing the content of the discrimination label by the alternative series data extraction device 2. In the example of FIG. 12, the contents of the discrimination labels of “service 2”, “service 3”, “service 4”, and “service 5” output as the peripheral series are converted from those after the occurrence of the event to those before the occurrence of the event.

Following step S125, in step S126, the CPU 11 estimates the specific series in which the peripheral series exists in the periphery using the peripheral series obtained by converting the content of the discrimination label and the parameter of the second model 4.

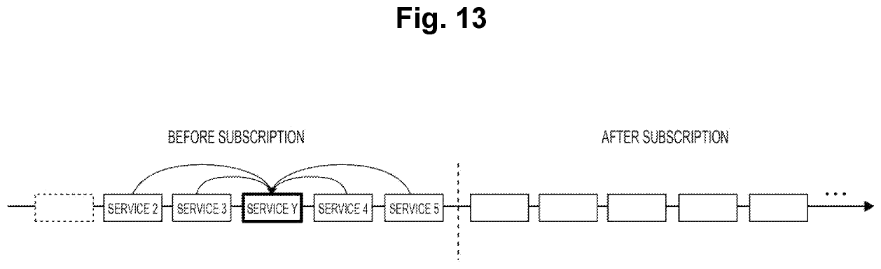

FIG. 13 is a diagram for explaining estimation processing of a specific series by the alternative series data extraction device 2. The example of FIG. 13 illustrates that “service Y” is estimated as a specific series in which a peripheral series including “service 2”, “service 3”, “service 4”, and “service 5” exists in the periphery. That is, it can be seen that the user uses “Service Y” after using “service 2” and “service 3” and before using “service 4” and “Service 5”. That is, it can be seen that the user has used the “service Y” before the subscription to the “service X”. In other words, it can be seen that the user does not use “service Y” anymore due to the subscription to the “service X”.

Following step S126, in step S127, the CPU 11 outputs the specific series estimated in step S126. For example, the CPU 11 outputs “service Y” estimated as the specific series in the example of FIG. 13.

By performing a series of processes, the alternative series data extraction device 2 can estimate a series limited to the semantic space before the occurrence of the event using the estimation time series data. For example, the alternative series data extraction device 2 can specify a service that is no longer used due to subscription to a certain service by executing a series of processes.

As described above, according to the embodiment of the present disclosure, the learning device 1 that creates different models by learning using time series data is provided. Furthermore, according to the embodiment of the present disclosure, the alternative series data extraction device 2 that estimates a series using different models created by learning using time series data is provided. In the embodiment of the present disclosure, by learning using the Skip-Gram method and the CBOW method, it is possible to obtain an explanatory property for the result as compared with inference by a deep neural network (DNN).

For example, in a case where a customer subscribes to a new service, the alternative series data extraction device 2 according to the embodiment of the present disclosure can estimate, from the service use log, which service the new service has been used as a substitute for.

In the embodiment described above, the semantic vector generated at the time of learning by the Skip-Gram method or the CBOW method is not used for the estimation processing. In the present disclosure, instead of performing learning by the Skip-Gram method or the CBOW method, the Skip-Gram model and the CBOW model that inherit the BERT model may be configured using semantic vectors generated together with the BERT model learned for other purposes. By using the semantic vector generated together with the BERT model to construct the Skip-Gram model and the CBOW model that inherit the BERT model, it is possible to shorten the learning time as compared with the case of performing learning by the Skip-Gram method and the CBOW method from the beginning using the learning chronological data.

The learning processing or the alternative series data estimation processing executed by the CPU reading software (program) in each of the above embodiments may be executed by various processors other than the CPU. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). Furthermore, the learning processing and the alternative series data estimation processing may be executed by one of these various processors, or may be performed by a combination of two or more processors of the same type or different types (for example, a plurality of FPGAS, a combination of a CPU and an FPGA, and the like). More specifically, a hardware structure of the various processors is an electric circuit in which circuit elements such as semiconductor elements are combined.

Furthermore, in the above embodiments, the aspect in which the learning program and the alternative series data estimation program are stored (installed) in advance in the storage 14 or the storage 24 has been described, but the present invention is not limited thereto. The program may be provided by being stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

Regarding the above embodiments, the following supplementary notes are further disclosed.

### (Supplementary Note 1)

A learning device comprising:
a memory; and
at least one processor connected to the memory,
wherein the processor is configured to
generate a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event, and
generate a second model that estimates a specific series in which a peripheral series exists in the periphery from the peripheral series by using the training time

### (Supplementary Note 2)

An alternative series data extraction device comprising:
a memory; and
at least one processor connected to the memory,
wherein the processor is configured to
estimate a peripheral series of a predetermined series from the predetermined series including one or more items after occurrence of an event in estimation time series data including a series indicating an action of a user, the estimation time series data being assigned with a date and time information label indicating a date and time when an action is performed and a discrimination label for discriminating before and after occurrence of the event, by using a first model that has been learned using the training time series data including a plurality of series indicating an action of the user and predicts a peripheral series of a series from the series including one or more items, each item of the training time series data being assigned with the date and time information label and the discrimination label,
convert contents of the discrimination label of the peripheral series estimated after occurrence of the event and before occurrence of the event, and
estimate a specific series from the peripheral series in the estimation time series data that has been estimated by using the first model and whose contents of the discrimination label has been converted, by using a second model that has been learned using the training time series data and estimates a specific series in which a peripheral series exists in the periphery from the peripheral series.

### (Supplementary Note 3)

A non-transitory storage medium storing a program executable by a computer to execute learning processing
the learning processing including
generating a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event, and
generating a second model that estimates a specific series in which a peripheral series exists in the periphery from the peripheral series by using the training time

### (Supplementary Note 4)

A non-transitory storage medium storing a program executable by a computer to execute alternative series data extraction processing
the alternative series data extraction processing including
estimating a peripheral series of a predetermined series from the predetermined series including one or more items after occurrence of an event in estimation time series data including a series indicating an action of a user, the estimation time series data being assigned with a date and time information label indicating a date and time when an action is performed and a discrimination label for discriminating before and after occurrence of the event, by using a first model that has been learned using the training time series data including a plurality of series indicating an action of the user and predicts a peripheral series of a series from the series including one or more items, each item of the training time series data being assigned with the date and time information label and the discrimination label,
converting contents of the discrimination label of the peripheral series estimated after occurrence of the event and before occurrence of the event, and
estimating a specific series from the peripheral series in the estimation time series data that has been estimated by using the first model and whose contents of the discrimination label has been converted, by using a second model that has been learned using the training time series data and estimates a specific series in which a peripheral series exists in the periphery from the peripheral series.

### REFERENCE SIGNS LIST

1 Learning device
2 Alternative series data extraction device
3 First model
4 Second model

1. A learning device comprising:
a first learning device that learns a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event; and
a second learning device that learns a second model that estimates a specific series in which a peripheral series exists in the periphery from the peripheral series by using the training time series data.

2. The learning device according to claim 1, wherein the event is subscription to a new service by the user.

3. An alternative series data extraction device comprising:
a first estimation device that estimates a peripheral series of a predetermined series from the predetermined series including one or more items after occurrence of an event in estimation time series data including a series indicating an action of a user, the estimation time series data being assigned with a date and time information label indicating a date and time when an action is performed and a discrimination label for discriminating before and after occurrence of the event, by using a first model that has been generated using training time series data including a plurality of series indicating an action of the user and predicts a peripheral series of a series from the series including one or more items, each item of the training time series data being assigned with the date and time information label and the discrimination label;
a conversion device that converts contents of the discrimination label of the peripheral series estimated by the first estimation unit from after occurrence of the event to before occurrence of the event; and
a second estimation device that estimates a specific series from the peripheral series in the estimation time series data that has been estimated by the first estimation unit and whose contents of the discrimination label have been converted by the conversion unit, by using a second model that has been generated by using the training time series data and estimates a specific series in which a peripheral series exists in the periphery from the peripheral series.

4. The alternative series data extraction device according to claim 3, wherein the event is subscription to a new service by the user.

5. A learning method in which a computer executes processing of:
generating a first model that estimates a peripheral series of a series from the series including one or more items by using training time series data including a plurality of series indicating an action of a user, each item in the training time series data being assigned with a date and time information label indicating a date and time when an action is performed and a discrimination label for discriminating before and after occurrence of an event; and
generating a second model that estimates a specific series in which a peripheral series exists in the periphery from the peripheral series by using the training time series data.

6. An alternative series data extraction method in which a computer executes processing of:
estimating a peripheral series of a predetermined series from a predetermined series including one or more items after occurrence of an event in estimation time series data including a series indicating an action of a user, the estimation time series data being assigned with a date and time information label indicating a date and time when an action is performed and a discrimination label for discriminating before and after occurrence of the event, by using a first model that has been learned using training time series data including a plurality of series indicating an action of the user and predicts a peripheral series of a series from the series including one or more items, each item of the training time series data being assigned with the date and time information label and the discrimination label;
converting contents of the discrimination label of the peripheral series estimated from after occurrence of the event to before occurrence of the event; and
estimating a specific series from the peripheral series in the estimation time series data that has been estimated by using the first model and whose contents of the discrimination label has been converted, by using a second model that has been learned using the training time series data and estimates a specific series in which a peripheral series exists in the periphery from the peripheral series.

7. A computer program for causing a computer to function as the learning device according to claim 1.

8. A computer program for causing a computer to function as the data extraction device according to claim 3.
